(19) United States
(12) Patent Application Publication
(10) Pub. No.: US 2023/0191206 A1
(43) Pub. Date: Jun. 22, 2023

(54) LIGHT-EMITTING GOLF BALL USING SMALL GENERATOR

(71) Applicant: ChaeHyun Lim, Seoul (KR)

(72) Inventor: ChaeHyun Lim, Seoul (KR)

(73) Assignee: ChaeHyun Lim, Seoul (KR)

(21) Appl. No.: 17/689,479

(22) Filed: Mar. 8, 2022

(30) Foreign Application Priority Data
Dec. 22, 2021 (KR) 10-2021-0185082

(51) Int. Cl. A63B 43/06; A63B 37/00; F21L 13/06; F21V 9/30; H02K 11/00

(52) U.S. Cl. CPC A63B 43/06; A63B 37/0075; F21L 13/06; F21V 9/30; H02K 11/0094; A63B 2225/74; A63B 2225/76

(57) ABSTRACT

A light-emitting golf ball using a small generator includes a core that is a center point of the golf ball; an inner shell formed to surround the core; an outer shell formed to surround an outer surface of the inner shell and struck by a golf club; a generator positioned on one side of the inner shell and generating a current based on a rotational force caused by a stroke; and a light emitting portion located on one side of the inner shell and providing light so that the golf ball emits light based on the generated current. According to the present disclosure, the golf ball emits light, and thus it is easy to track a trajectory of the golf ball. In addition, it is possible to more easily determine the trajectory and position of the golf ball when the day is cloudy or enters the night.

### TECHNICAL FIELD

The present disclosure relates to a light-emitting golf ball using a small generator, and more particularly, to a golf ball that generates a current from a small generator based on a rotational force caused by a stroke of a golf club and emits light using the generated current.

### BACKGROUND ART

Golf is a sport that competes for superiority by hitting a golf ball one after another with a golf club and battling the number of strokes required until the golf ball is put into a determined hole.

Generally, golf courses use a wide area of 660,000 to 1 million m², such as fields and forests, and include a seaside course built on the beach and an inland course built inland. At this time, obstacles such as forests, valleys, ponds, and small mountains are artificially created on the wide course, or natural rivers and seas are used.

Although such a golf sport uses a relatively small-sized golf ball even for a wide course, when the golf ball flies a long distance (yard) at once, such as a driver or a wood, a situation in which the golf ball instantly disappears from a view, making it difficult to determine an exact drop point occurs frequently.

In addition, when a professional player takes a driver shot in a golf tournament, the professional player and gallery immediately behind the professional player may see the golf ball until it falls on the field, but a phenomenon in which the gallery viewed from the side misses the golf ball from the view occurs.

This problem makes it more difficult to find the golf ball when the day is cloudy or enters into the night, and when the golf ball falls on an obstacle other than grass, OB, or a hazard area.

Conventionally, to solve this problem, the golf ball was used by coloring or coating a surface thereof with a luminous material, but this surface coating method has a problem that coating is peeled off when struck by a golf club or used for a long time, and the original function is not achieved.

In addition, a method of illuminating a light emitting diode by putting a battery inside a golf ball was also used, but there was disadvantages that a battery life is short and the golf ball needs to be replaced when the battery is exhausted because it is impossible to replace the battery.

### DISCLOSURE

### TECHNICAL PROBLEM

An object of the present disclosure is to propose a light-emitting golf ball using a small generator.

### TECHNICAL SOLUTION

According to an exemplary embodiment of the present disclosure, a light-emitting golf ball using a small generator includes a core that is a center point of the golf ball; an inner shell formed to surround the core; an outer shell formed to surround an outer surface of the inner shell and struck by a golf club; a generator positioned on one side of the inner shell and generating a current based on a rotational force caused by a stroke; and a light emitting portion located on one side of the inner shell and providing light so that the golf ball emits light based on the generated current.

A first concave groove may be formed in an inner surface of the inner shell, and a second concave groove facing the first concave groove may be formed in an outer surface of the core.

The generator may include a coil portion wounded with a plurality of coils; a magnet portion rotatably positioned inside the coil portion and forming a magnetic field; and a guide shaft connected to both sides of the magnet portion and guiding a rotation of the magnet portion, and wherein the guide shaft may include a first guide shaft having one end formed in a spherical shape and rotatably positioned in the first concave groove, and the other end connected to one side of the magnet portion; and a second guide shaft having one end formed in a spherical shape and rotatably positioned in the second concave groove, and the other end connected to one side of the magnet portion.

The coil portion may be rotated at a first rotational speed together with the golf ball by a rotational force caused by a stroke, the magnet portion may be rotated at a second rotational speed separately from the golf ball by the guide shaft, and the first rotation speed may be faster than the second rotation speed, and the current may be generated by a difference between rotation speeds of the coil portion and the magnet portion.

The generator may further include a spring positioned between the guide shaft and the magnet portion and preventing the generator from being distorted due to an impact by a golf club, and the spring may include a first spring positioned between the first guide shaft and the magnet portion and a second spring positioned between the second guide shaft and the magnet portion.

The generator may be positioned on at least one or more rotational shafts of the golf ball.

The generator may include a first generator and a second generator symmetrical to each other on a rotation shaft of the golf ball with the core as a reference point.

The light emitting portion may be connected in parallel with the generator positioned on at least one or more rotational shafts.

The light emitting portion may be connected to each of generators positioned on at least one or more rotational shafts and provides light of different colors for each of the rotational shafts.

A fluorescent material may be attached to an outer surface of the inner shell.

The outer shell may be formed of a material through which the light generated by the light emitting portion is able to be transmitted.

### ADVANTAGEOUS EFFECTS

According to the various exemplary embodiments of the present disclosure described above, the golf ball emits light, and thus it is easy to track a trajectory of the golf ball.

In addition, it is possible to more easily determine a trajectory and a position of the golf ball when the day is cloudy or enters the night.

In addition, the golf ball of the present disclosure may be used semi-permanently by using a small generator instead of a battery.

In addition, the golf ball of the present disclosure may prevent a generator from being damaged due to an impact by a golf club through a spring.

### DESCRIPTION OF DRAWINGS

FIG. 1 is an exemplary view showing a cross-section of a golf ball according to an embodiment of the present disclosure.

FIG. 2 is an exemplary view showing a generator according to an embodiment of the present disclosure.

FIG. 3 is an exemplary view illustrating an operation principle of a golf ball according to an embodiment of the present disclosure.

FIG. 4 is an exemplary view briefly showing an inside of a golf ball according to an embodiment of the present disclosure.

FIG. 5 is an exemplary view illustrating a rotation shaft of a golf ball according to an embodiment of the present disclosure.

### BEST MODE

The following description illustrates only a principle of the present disclosure. Therefore, those skilled in the art may invent various devices that implement the principle of the present disclosure and are included in the spirit and scope of the present disclosure although they are not clearly described or shown in the present specification. In addition, it is to be understood that all conditional terms and exemplary embodiments listed in the present specification are obviously intended only to allow those skilled in the art to understand a concept of the present disclosure in principle, and the present disclosure is not limited to the exemplary embodiments and states particularly listed as described below.

The above-mentioned objects, features, and advantages will become more obvious from the following detailed description provided in relation to the accompanying drawings. Therefore, those skilled in the art to which the present disclosure pertains may easily practice a technical idea of the present disclosure.

Further, in describing the present disclosure, in the case in which it is determined that a detailed description of a known technology associated with the present disclosure may unnecessarily make the gist of the present disclosure unclear, it will be omitted. Hereinafter, exemplary embodiments of the present disclosure will be described in detail with reference to the accompanying drawings.

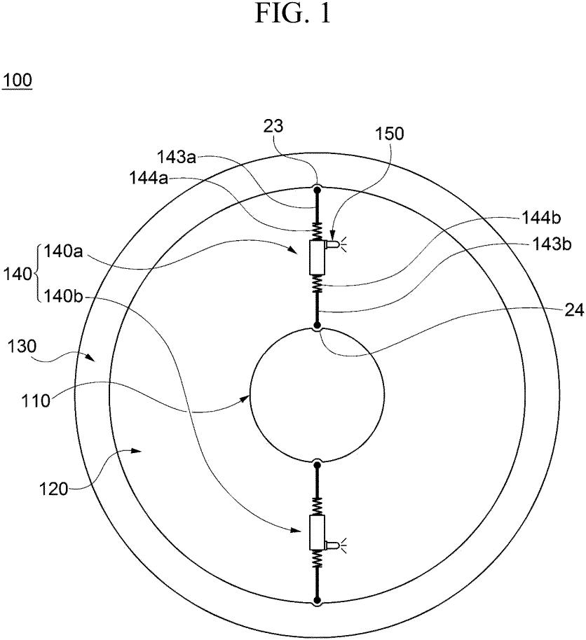

First, each configuration of a golf ball 100 that emits light using a small generator will be described with reference to FIG. 1.

FIG. 1 is an exemplary view showing a cross-section of a golf ball 100 according to an embodiment of the present disclosure.

Referring to FIG. 1, the golf ball 100 that emits light using a small generator may include a core 110, an inner shell 120, an outer shell 130, a generator 140, and a light emitting portion 150.

Specifically, the core 110 may be positioned in the center of the golf ball 100 in a spherical shape that is a center point of the center of gravity of the golf ball 100.

In addition, a second concave groove 24 facing a first concave groove 23 formed in an inner surface of the inner shell 120 may be formed in an outer surface of the core 100. Here, the second concave groove 24 may be formed to correspond to the number of guide shafts 143.

The inner shell 120 may be formed to surround an outer surface of the core 110 in a spherical shape, the inner shell 120 may be formed of a material through which light generated from the light emitting portion 150 may be transmitted, and the outer surface of the inner shell 120 may be coated with a fluorescent material. Here, the fluorescent material may be emitted based on light energy absorbed from the light emitting portion 150.

In addition, the first concave groove 23 may be formed in the inner surface of the inner shell 120 to face the second concave groove 24 of the core 110.

That is, the first concave groove 23 and the second concave groove 24 may be positioned on the same rotation shaft.

The outer shell 130 may be a part formed to surround the outer surface of the inner shell 120 in a spherical shape and hit by a golf club, and a plurality of dimples may be formed in an outer surface of the outer shell 130. In addition, the outer shell 130 may be formed of a material through which light generated by the light emitting portion 150 or light by the fluorescent material applied to the inner shell 120 may be transmitted. For example, the outer shell 130 may be formed of a translucent material.

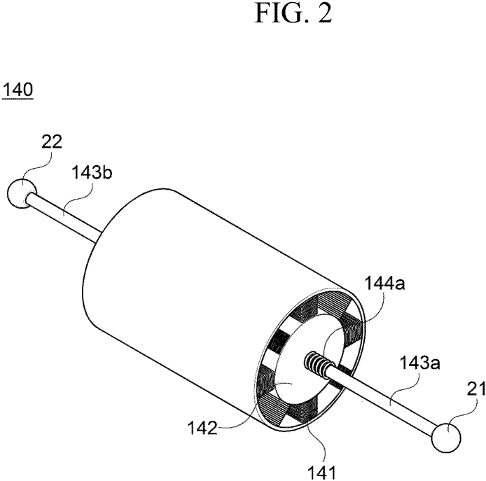

The generator 140 may be positioned on one side of the inner shell 120 of the golf ball 100 to generate a current based on a rotational force caused by a stroke. In this regard, the configuration of the generator 140 will be described with reference to FIG. 2.

Referring additionally to FIG. 2, the generator 140 may include a coil portion 141, a magnet portion 142, a guide shaft 143, and a spring 144.

Specifically, the coil portion 141 may be in a cylindrical shape, have an inner space into which the magnet portion 142 may be inserted formed inside, have a plurality of coils wound on an inner surface, fixed to the inner shell 120 of the golf ball 100, and may be rotated together when the golf ball 100 is rotated.

The magnet portion 142 may be inserted into the inner space of the coil portion 141 and rotatably positioned to form a magnetic field. Here, the magnet portion 142 may be a permanent magnet, or an electromagnet if necessary.

In addition, between the coil portion 141 and the magnet portion 142 of the generator 140 may be filled with a material (air, vacuum, water, low-viscosity oil, etc.) capable of generating a rotational speed difference to be sealed.

The guide shaft 143 may be connected to both sides of the magnet portion 142 to guide a rotation of the magnet portion 142.

Specifically, one end of the guide shaft 143 may be formed in a spherical shape 21 and rotatably positioned in the first concave groove 23 formed in the inner surface of the inner shell 120, and one end of the other end may be formed in a spherical shape 22 with a first guide shaft 143a connected to one side of the magnet portion 142 and rotatably positioned in the second concave groove 24 formed in the core 110, and the other end may be configured as a second guide shaft 143b connected to one side of the magnet portion 142. In this case, the guide shaft 143 may be indirectly connected to both ends of the magnet portion 142 through the spring 144.

The guide shaft 143 may be positioned on a rotation shaft of the golf ball 100 to guide the magnet portion 142 not to move in a direction other than the rotation shaft and may prevent the magnet portion 142 and the coil portion 141 from colliding with each other.

That is, the guide shaft 143 may guide a rotation of the generator 140 so as to rotate only with the rotation shaft and prevent the generator 140 from being damaged.

The spring 144 may be positioned between the guide shaft 143 and the magnet portion 142 to absorb an impact transferred to the generator 140.

Specifically, the spring 144 may include a first spring 144a positioned between the first guide shaft 143a and the magnet portion 142 and a second spring 144b positioned between the second guide shaft 143b and the magnet portion 142.

Meanwhile, the spring 144 may be omitted in the golf ball 100 in some cases. In this case, the guide shaft 143 may be directly connected to both sides of the magnet portion 142 to guide the rotation of the magnet portion 142.

In addition, the above-described generator 140 may be similar to a structure of a small dynamo, and although not shown, may additionally include a configuration necessary for generating a current (e.g., a commutator, a brush, a fan wheel, etc.)

Meanwhile, the generator 140 may be positioned on at least one or more rotation shafts of the golf ball 100, the generator 140 may include a first generator 140a and a second generator 140b which are symmetrical to each other on the rotation shaft of the golf ball 100 with the core as a reference point. That is, the generator 140 may be positioned on one rotation shaft in a pair.

Again, referring to FIG. 1, the light emitting portion 150 may be positioned on one side of the inner shell 120 to provide light so that all or part of the golf ball is emitted based on the current generated by the generator 140.

Specifically, the light emitting portion 150 may include at least one light emitting element. For example, the light emitting portion 150 may include a plurality of light emitting diodes (LEDs), and may be diodes that emit light of a plurality of colors.

In FIG. 1, the light emitting portion 150 is positioned on one side of the generator 140, but the present disclosure is not limited thereto.

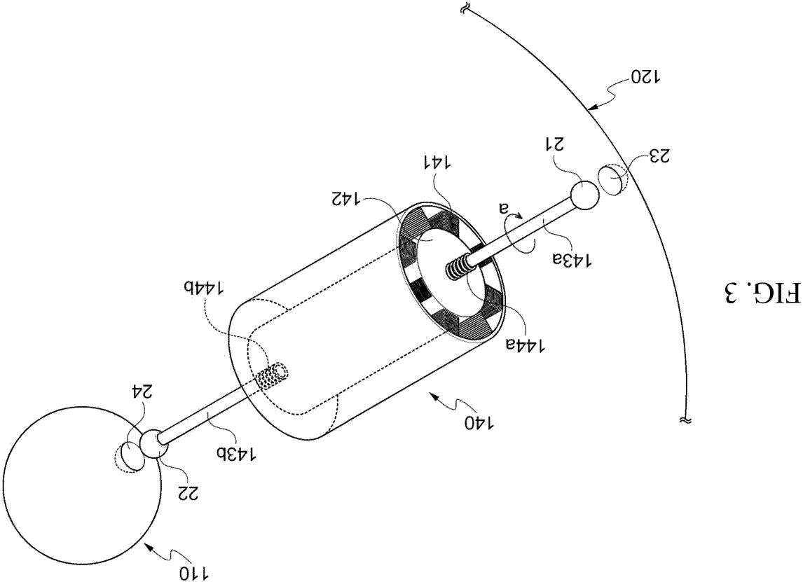

Hereinafter, an operation principle of the golf ball 100 that emits light using a small generator will be described with reference to FIG. 3.

FIG. 3 is an exemplary view showing an operation principle of the golf ball 100 according to an embodiment of the present disclosure.

Referring to FIG. 3, when a user strikes the golf ball 100 with a golf club, the golf ball 100 may rotate by a stroke, and the generator 140 of the golf ball 100 may generate a current by using a rotational force caused by the stroke.

For example, when the golf ball 100 is rotated at a first rotational speed in a (a) direction due to the stroke by the golf club, the coil portion 141 fixed to the inner shell 120 may be rotated at a first rotational speed in the (a) direction.

In addition, the magnet portion 142 may be rotated at a second rotational speed that is an individual rotational speed from the first rotational speed of the golf ball 100 through the first guide shaft 143a and the second guide shaft 143b rotatably positioned in the first concave groove 23 and the second concave groove 24, respectively. Here, the magnet portion 142 may be rotated at the second rotational speed slower than the first rotational speed of the golf ball 100 through a resistance force due to a material filled inside the generator 140.

That is, the coil portion 141 of the generator 140 may be rotated at the first rotational speed together with the golf ball 100 rotating by the rotational force caused by the stroke, and the magnet portion 142 of the generator 140 may be rotated at the second rotational speed separately from the golf ball 100 rotated by the guide shaft 143.

As described above, the generator 140 may generate a current through a temporal change rate of a magnetic flux according to a difference in the rotational speed between the coil portion 141 and the magnet portion 142.

In addition, the light emitting portion 150 may operate the light emitting element based on the current generated by the generator 140 to cause the golf ball 100 to emit light.

Meanwhile, the generator 140 may be positioned on a plurality of rotation shafts of the golf ball 100, and the generator 140 may be positioned to be symmetrical to each other on the rotation shaft of the golf ball 100 with the core 110 as a reference point.

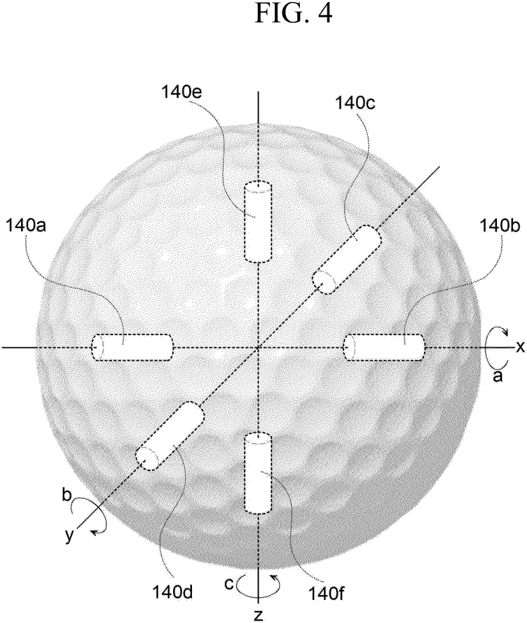

In this regard, it will be described with reference to FIG. 4.

FIG. 4 is an exemplary view briefly showing inside of a golf ball according to an embodiment of the present disclosure.

FIG. 4 schematically shows rotation shafts (an X-shaft, a Y-shaft, and a Z-shaft) of the golf ball 100 and a plurality of generators 140a, 140b, 140c, 140d, 140e and 140f: 140 therein.

Referring to FIG. 4, the generator 140 may be positioned on a plurality of rotation shafts of the golf ball 100, and the plurality of generators 140a, 140b, 140c, 140d, 140e and 140f: 140 may be positioned to be symmetrical to each other on the respective rotation shafts.

Specifically, in the generator 140 on the X-shaft, the first generator 140a and the second generator 140b may be positioned so as to be symmetrical with respect to a center portion of the golf ball 100, in the generator 140 on the Y-shaft, the first generator 140c and the second generator 140d may be positioned so as to be symmetrical with respect to the center portion of the golf ball 100, and in the generator 140 on the Z-shaft, the first generator 140e and the second generator 140f may be positioned so as to be symmetrical with respect to the center portion of the golf ball 100.

As the generator 140 is positioned on each of the plurality of rotation shafts as described above, even if the golf ball 100 is rotated in several rotation shaft directions, the generator 140 of the golf ball 100 may generate a current.

For example, when the golf ball 100 is rotated in the (a) direction, the first generator 140a and the second generator 140b may generate a current, when the golf ball 100 is rotated in the (b) direction, the first generator 140c and the second generator 140d may generate a current, and when the golf ball 100 is rotated in the (c) direction, the first generator 140e and the second generator 140f may generate a current. That is, only the generator 140 positioned on the shaft on which the golf ball 100 rotates may generate a current.

Meanwhile, the light emitting portion 150 may be connected in parallel with the generator 140 positioned on at least one or more rotation shafts.

As such, when the light emitting portion 150 is connected in parallel with the plurality of generators 140, the light emitting portion 150 may provide light even if a generator on any rotation shaft generates a current.

For example, when the light emitting element of the light emitting portion 150 is connected in parallel with the generators 140a, 140b, 140c, 140d, 140e and 140f positioned on the X-shaft, Y-shaft, and Z-shaft, even if a rotation direction of the golf ball 100 is changed in the middle from the (a) direction to the (b) direction, the golf ball 100 may continuously emit light.

That is, the golf ball 100 may emit light without being affected by the rotation shaft and the rotation direction.

Through this, the user may easily track a trajectory of the golf ball 100.

In addition, the light emitting portion 150 may be respectively connected to the generator 140 positioned on at least one or more rotation shafts, and may provide light of different colors for each rotation shaft.

Specifically, the light emitting portion 150 has a configuration in which each light emitting element is connected for each generator 140 positioned on the rotation shaft, and light emitting elements of different colors may be connected for each rotation shaft. At this time, each light emitting element may be operated using only the current generated by the connected generator 140.

As such, when the light emitting element is connected for each rotation shaft, the golf ball 100 may emit light in different colors according to the rotation direction.

For example, when the light emitting element of the light emitting portion 150 includes red light emitting elements connected to the generators 140a and 140b positioned on the X-shaft, green light emitting elements connected to the generators 140c and 140d positioned on the Y-shaft, and blue light emitting elements connected to the generators 140e and 140f positioned on the Z-shaft, and when the golf ball 100 rotates between the (a) and (b) directions, similar to a light emitting effect according to RGB, the golf ball 100 may emit light at a ratio according to a distance between the shaft and rotation direction.

That is, the golf ball 100 may emit light in a different color according to the rotation direction.

For example, when a tee shot is performed with the golf ball 100 placed at a determined position, the user may determine a current rotation direction of the golf ball 100 by using an emitted color of the golf ball 100.

Alternatively, after matching a putting line for putting with at least one shaft, it is also possible to determine whether putting is correctly performed according to an emission form of the golf ball 100.

Therefore, a putting guide line generally printed on the outer shell 130 of the golf ball 100 may coincide with a direction of at least one guide shaft 143, and through this, it is also possible to correct a swing through rotation upon more sophisticated putting of the golf ball 100.

In addition, when the rotation of the golf ball 100 is stopped, the golf ball 100 may emit light through a fluorescent material applied to the inner shell 120. Here, the fluorescent material may emit light by absorbing light energy based on the light provided by the light emitting portion 150.

Through this, even when the golf ball 100 arrives at a destination and stops, it is possible to easily determine a position of the golf ball 100.

In addition, it may be used to determine whether the golf ball 100 is completely stopped through the golf ball 100 emitting light with the fluorescent material instead of the light emitting element.

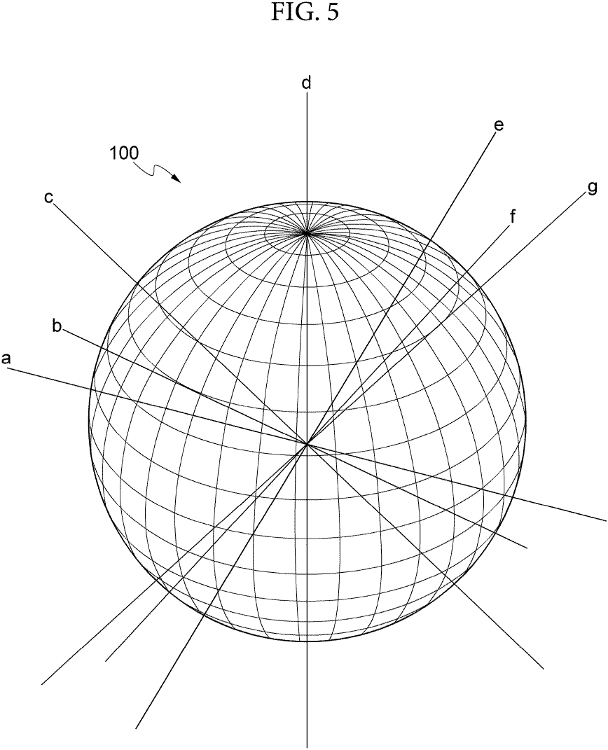

Meanwhile, although the generator 140 positioned on three rotation shafts is illustrated in FIG. 4, the generator 140 may be positioned on the rotation shafts in more directions according to the structure or necessity of the golf ball 100. In this regard, it will be described with reference to FIG. 5.

FIG. 5 is an exemplary view showing a rotation shaft of the golf ball 100 according to an embodiment of the present disclosure.

Referring to FIG. 5, the golf ball 100 may have the generator 140 positioned on seven rotation shafts as shown in a to g.

As described above, when the generator 140 is positioned on the seven rotation shafts inside the golf ball 100, the golf ball 100 rotating in various directions may also emit light by using a rotational force. For example, the golf ball 100 may emit light using rotations up and down, left and right, front and back and therebetween through the generator 140 positioned on the seven rotation shafts.

The golf ball 100 may fly in various ball qualities according to a head surface and an entry angle of a head of a striking club, and generally it is also possible to distinguish seven representative types of ball qualities of straight, a slice that curves to the left, a hook that curves to the right, draw that starts from the right and curves to the left, fade that starts from the left and curves to the right, and pull and push that are pulled or pushed, by a combination of emitted colors through the rotation axis

Meanwhile, the structure of the present disclosure described above is not limited to the golf ball 100, and may be applied to sports using a rotating ball.

For example, the above-described operation structure of the golf ball 100 may be applied to a ball used in sports such as soccer, basketball, volleyball, tennis, and lacrosse.

Meanwhile, according to the present disclosure described above, the light-emitting golf ball 100 using a small generator may generate a current by using a spin of the golf ball 100 by a stroke, and based on the generated current, the golf ball 100 may emit light.

The golf ball 100 of the present disclosure emits light, and thus it is easy to track a trajectory of the golf ball 100. In particular, it is possible to more easily determine the trajectory and position of the golf ball 100 when the day is cloudy or enters the night.

In addition, the golf ball 100 of the present disclosure may be used semi-permanently, by using the small generator instead of a battery.

In addition, the golf ball 100 of the present disclosure may prevent the generator 140 from being distorted or damaged due to an impact by a golf club through the spring 144.

The terms “first,” “second,” “third,” “fourth,” and the like in the description and in the claims, are used for distinguishing between similar elements and not necessarily for describing a particular sequential or chronological order. It is to be understood that the terms are interchangeable under appropriate circumstances such that the embodiments of the disclosure described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. For example, without departing from the scope of the present disclosure, a first element may be referred to as a second element, and similarly, a second element may also be referred to as a first element.

In addition, in the specification and claims, references to “connected”, “connecting”, “fastened”, “fastening”, “coupled”, “coupling”, etc. and various modifications of such expressions are used in a sense including being directly connected to another element or indirectly connected through another element.

Meanwhile, when an element is referred to as being “directly coupled” to another element, it will be understood that there are no intervening elements present.

In addition, the suffixes “module” and “portion” for the elements used in the present specification are given or mixed in consideration of the ease of drafting the specification, and do not have distinct meanings or roles by themselves.

The terminology used herein is for the purpose of describing particular embodiments only and is not intended to be limiting of the present disclosure. As used herein, the singular forms are intended to include the plural forms as well, unless the context clearly indicates otherwise. In the present application, terms such as “comprises” or “includes” should not be construed as necessarily including all of the various elements or various steps described in the specification, and should be construed as not including some of the elements or some of the steps or further including additional elements or steps.

Up to now with respect to the present disclosure, the preferred embodiments have been described. All embodiments and conditional examples disclosed through the present specification have been described with the intention of helping those of ordinary skill in the art to understand the principles and concepts of the present disclosure, and it will be understood by those skilled in the art that the present disclosure may be implemented in a modified form without departing from the essential features of the present disclosure.

Therefore, the disclosed embodiments are to be considered in an illustrative rather than a restrictive sense. The scope of the present disclosure is indicated in the claims rather than the foregoing description, and all differences within the scope equivalent thereto should be construed as being included in the present disclosure.

In addition, although preferred embodiments of the present disclosure have been illustrated and described above, the present disclosure is not limited to the specific embodiments described above, and various modifications are possible by those of ordinary skill in the art to which the present disclosure pertains without departing from the gist of the present disclosure as claimed in the claims, and these modifications should not be individually understood from the technical spirit or perspective of the present disclosure.

1. A light-emitting golf ball using a small generator, the golf ball comprising:
a core that is a center point of the golf ball;
an inner shell formed to surround the core;
an outer shell formed to surround an outer surface of the inner shell and struck by a golf club;
a generator positioned on one side of the inner shell and generating a current based on a rotational force caused by a stroke; and
a light emitting portion located on one side of the inner shell and providing light so that the golf ball emits light based on the generated current.

2. The golf ball of claim 1, wherein
a first concave groove is formed in an inner surface of the inner shell, and
a second concave groove facing the first concave groove is formed in an outer surface of the core.

3. The golf ball of claim 2, wherein
the generator includes
a coil portion wounded with a plurality of coils;
a magnet portion rotatably positioned inside the coil portion and forming a magnetic field; and
a guide shaft connected to both sides of the magnet portion and guiding a rotation of the magnet portion, and wherein the guide shaft includes
a first guide shaft having one end formed in a spherical shape and rotatably positioned in the first concave groove, and the other end connected to one side of the magnet portion; and
a second guide shaft having one end formed in a spherical shape and rotatably positioned in the second concave groove, and the other end connected to one side of the magnet portion.

4. The golf ball of claim 3, wherein
the coil portion is rotated at a first rotational speed together with the golf ball by a rotational force caused by a stroke,
the magnet portion is rotated at a second rotational speed separately from the golf ball by the guide shaft, and
the first rotation speed is faster than the second rotation speed, and the current is generated by a difference between rotation speeds of the coil portion and the magnet portion.

5. The golf ball of claim 3, wherein
the generator further includes a spring positioned between the guide shaft and the magnet portion and preventing the generator from being distorted due to an impact by a golf club, and
the spring includes a first spring positioned between the first guide shaft and the magnet portion and a second spring positioned between the second guide shaft and the magnet portion.

6. The golf ball of claim 3, wherein
the generator is positioned on at least one or more rotational shafts of the golf ball.

7. The golf ball of claim 6, wherein
the generator includes a first generator and a second generator symmetrical to each other on a rotation shaft of the golf ball with the core as a reference point.

8. The golf ball of claim 6, wherein
the light emitting portion is connected in parallel with the generator positioned on at least one or more rotational shafts.

9. The golf ball of claim 6, wherein
the light emitting portion is connected to each of generators positioned on at least one or more rotational shafts and provides light of different colors for each of the rotational shafts.

10. The golf ball of claim 1, wherein
a fluorescent material is attached to an outer surface of the inner shell.

11. The golf ball of claim 1, wherein
the outer shell is formed of a material through which the light generated by the light emitting portion is able to be transmitted.
